(19) United States
(12) Patent Application Publication
(10) Pub. No.: US 2009/0204606 A1
(43) Pub. Date: Aug. 13, 2009

(54) FILE MANAGEMENT SYSTEM, FILE MANAGEMENT METHOD, AND STORAGE MEDIUM

(75) Inventor: Tomoaki Osada, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/365,701

(22) Filed: Feb. 4, 2009

(30) Foreign Application Priority Data
Feb. 7, 2008 (JP) 2008-027802

(51) Int. Cl. G06F 17/30

(52) U.S. Cl. 707/5; 707/3; 707/10; 707/E17.01; 707/E17.014; 707/E17.032

(57) ABSTRACT

A file management apparatus which makes it possible to cache a file registered in a file server from an initial stage of registration thereof. When a file is newly registered in the file server, the file server extracts the feature elements of the file, and searches for an registered file having a high degree of similarity to the file being registered in response to the current registration request. The search is performed based on the feature elements and an access log. Then, the file server searches for a domain from which access has been made to the file a not smaller number of times than a predetermined number of times, and copies and registers the newly registered file also in a cache server of the domain.

### BACKGROUND OF THE INVENTION

1. Field of the Invention

The present invention relates to a file management apparatus for a file management system for sharing files between a plurality of client terminals, and more particularly to a technique for caching shared files stored in a file server.

2. Description of the Related Art

There have been conventionally provided a number of distributed file management systems in which file access speed is increased by caching shared files stored in a file server (file management apparatus) in client terminals (see Japanese Patent Laid-Open Publication No. H07-93205).

In another system, a server called a cache server, which is dedicated to caching, is disposed between a local area network and a wide area network, such that client terminals on the local area network acquire files from the file server via the cache server (see Japanese Patent Laid-Open Publication No. H11-24981).

In a still another system, files are cached in a gateway device connecting between the local area network and the wide area network such that the client terminals acquire files from the gateway device (see Japanese Patent Laid-Open Publication No. H04-313126).

As described above, by caching the files stored in the file server in a predetermined apparatus, the client terminals are not required to access the file server to acquire any of the files in using the same next time, which enables high-speed processing.

However, there is an upper limit to the capacity of a storage device for caching, which makes it impossible to cache all the files in the file server. Therefore, in the conventional caching method, the frequency of access to the same file is totalized, and when files accessed with a frequency higher than a predetermined threshold value, the files are cached.

As described above, when a file to be cached is selected based on the frequency of access thereto, the file is not cached in an initial stage where the file is registered in the file server. Therefore, client terminals which access a file registered in the file server in the initial stage of registration thereof cannot benefit from quick access, which causes inconvenience to the client terminals. This problem becomes particularly serious for documents frequently upgraded.

### SUMMARY OF THE INVENTION

The present invention provides a file management apparatus and a file management method, which make it possible to cache a file registered in a file server from an initial stage of registration thereof, and a storage medium for storing a program for implementing the file management method.

In a first aspect of the present invention, there is provided a file management apparatus that manages files shared by a plurality of client terminals, comprising a recording unit configured to record access situations in which access is made to the files registered in the file management apparatus from the client terminals, a search unit configured to search the recording unit for a file having a not smaller degree of similarity to a file newly registered in the file management apparatus than a predetermined threshold value, and a distribution unit configured to distribute the newly registered file to any of the client terminals from which access has been made to the file found by the search a not smaller number of times than a predetermined number of times.

In a second aspect of the present invention, there is provided a file management method for a file management apparatus, for managing files shared by a plurality of client terminals, comprising recording access situations in which access is made to the files registered in the file management apparatus from the client terminals, searching for a file having a not smaller degree of similarity to a file newly registered in the file management apparatus than a predetermined threshold value, and distributing the newly registered file to any of the client terminals from which access has been made to the file found by the search a not smaller number of times than a predetermined number of times.

In a third aspect of the present invention, there is provided a computer-readable storage medium storing a program for causing a computer to execute a file management method for a file management apparatus, for managing files shared by a plurality of client terminals, wherein the method comprises recording access situations in which access is made to the files registered in the file management apparatus from the client terminals, searching for a file having a not smaller degree of similarity to a file newly registered in the file management apparatus than a predetermined threshold value, and distributing the newly registered file to any of the client terminals from which access has been made to the file found by the search a not smaller number of times than a predetermined number of times.

According to the present invention, it is possible to cache a file registered in a file server from an initial stage of registration thereof. Therefore, depending on a history of access to the file server in the past, it is possible to acquire a file newly registered in the file server, from a cache server, which enables client terminals to acquire a file more efficiently.

The features and advantages of the invention will become more apparent from the following detailed description taken in conjunction with the accompanying drawings.

### BRIEF DESCRIPTION OF THE DRAWINGS

FIG. 1 is a schematic system diagram of a file management system according to an embodiment of the present invention.

FIG. 2 is a block diagram showing an example of the configuration of hardware of a file server.

FIG. 3 is a functional block diagram of the file server.

FIGS. 4A and 4B are conceptual diagrams showing a format of an access log.

FIG. 5 is a conceptual diagram showing a format of a print log.

FIG. 6 is a view of the appearance of an MFP (printing apparatus).

FIG. 7 is a block diagram showing the internal configuration of the MFP.

FIG. 8 is a flowchart showing a newly registering process for registering a new file.

FIG. 9 is a flowchart showing an example of an extraction process for extracting feature elements of a file in a step S802 appearing in FIG. 8.

FIG. 10 is a flowchart showing another example of the extraction process for extracting feature elements of a file in the step S802 appearing in FIG. 8.

FIG. 11 is a flowchart showing still another example of the extraction process for extracting feature elements of a file in the step S802 appearing in FIG. 8.

FIG. 12 is a flowchart showing details of a copying registration process in a step S804 appearing in FIG. 8.

FIG. 13 is a conceptual diagram showing an concept-based search process.

FIG. 14 is a flowchart showing details of a copying registration process in a step S805 appearing in FIG. 8.

FIG. 15 is a flowchart showing a process executed by the file server when an access request is received from a client PC.

FIG. 16 is a flowchart showing details of a process in a step S1503 appearing in FIG. 15.

FIG. 17 is a flowchart showing a process executed by the file server when a print request is received from the client PC.

FIG. 18 is a flowchart showing details of a process in a step S1703 appearing in FIG. 17.

### DETAILED DESCRIPTION OF THE EMBODIMENTS

The present invention will now be described in detail below with reference to the accompanying drawings showing an embodiment thereof.

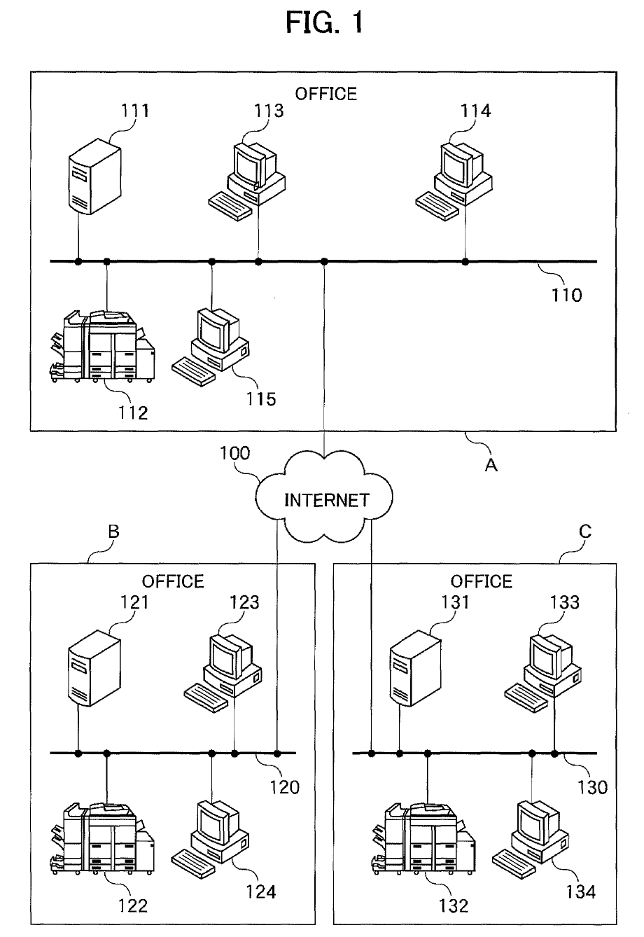

FIG. 1 is a schematic system diagram of a file management system according to an embodiment of the present invention.

As shown in FIG. 1, the file management system is constructed on a plurality of local area networks (hereinafter referred to as “the local networks) 110, 120, and 130 connected via a wide area network (hereinafter referred to as “the internet”) 100. In the present embodiment, it is assumed that the local networks 110, 120, and 130 are constructed in offices A, B, and C, respectively.

To the local networks 110, 120, and 130 are connected a file server 111, a cache server 121, and a cache server 131, respectively. Further, an MFP 112, and client PCs 113, 114, and 115 are connected to the network 110 in addition to the file server 111. An MFP 122, and client PCs 123 and 124 are connected to the network 120 in addition to the cache server 121. An MFP 132, and client PCs 133 and 134 are connected to the network 130 in addition to the cache server 131.

It should be noted that in the following description, the local networks 110, 120, and 130 are generically referred to as “the local network 110 and the like”, using the local network 110 as a representative thereof. Further, the plurality of client PCs 113, 114, 115, 123, 124, 133, and 134 are generically referred to as “the client PC 113 and the like”, using the client PC 113 as a representative thereof. Similarly, the cache servers 121 and 131 are generically referred to as “the cache server 121 and the like”, using the cache server 121 as a representative thereof. Similarly, the MFP 112, 122, and 132 are generically referred to as “the MFP 112 and the like”, using the MFP 112 as a representative thereof.

The file server 111, as an example of a file management apparatus, is for sharing files between the client PC 113 and the like, which are examples of client terminals, and has a plurality of files registered therein for management. In the present embodiment, the files managed by the file management apparatus include document data created e.g. by PC applications, and image data in various formats. This file sharing makes it possible to achieve saving in the total hardware resources among a plurality of the client PC 113 and the like. Further, the file server 111 and the plurality of the client PC 113 and the like are connected to each other via the network 100. Therefore, even if the file server 111 and the client PC 113 and the like are physically remote from each other, the client PC 113 and the like can access files on the file server 111.

The MFP 112 and the like are MFPs (Multi Function Peripherals) having a copy function, a print function, a FAX function, and so forth, installed thereon. The MFP 112 and the like each include storage devices, and are capable of storing various kinds of data.

The cache server 121 and the like are devices for holding copies of shared files which are managed by the file server 111 (hereinafter simply referred to as “the shared files”), i.e. devices dedicated to caching. These cache server 121 and the like have the following reason for existence: When a desired shared file exists on the cache server 121 connected to the local network 120 to which are connected the client PCs 123 and 124, the client PCs 123 and 124 acquire the shared file from the cache server 121 without accessing the file server 111. Similarly, when a desired shared file exists in the cache server 131 connected to the local network 130 to which are connected the client PCs 133 and 134, the client PCs 133 and 134 acquire the shared file from the cache server 131 without accessing the file server 111. Thus, even if the client PCs 123 and 124, and 133 and 134 exist at locations physically remote from the file server 111, they can acquire the shared files quickly.

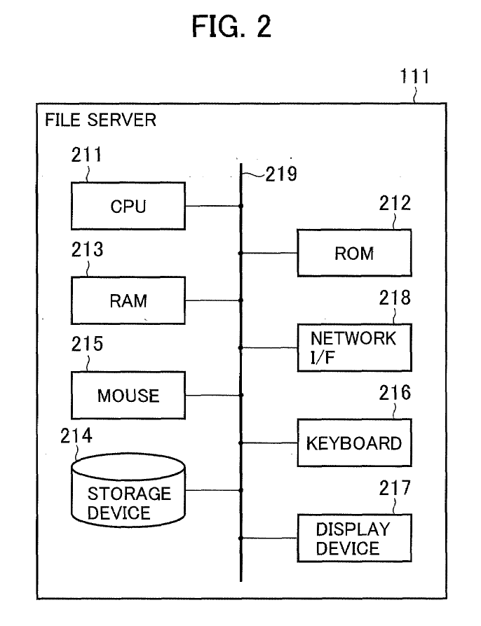

Next, an example of the hardware configuration of the file server 111 will be described with reference to FIG. 2. The file server 111 is formed by a personal computer (PC). More specifically, the file server 111 is comprised of a CPU 211, a ROM 212, a RAM 213, a storage device 214, a mouse 215, a keyboard 216, a display device 217, and a network I/F 218.

These devices are connected via a bus 219. Further, the file server 111 is connected to the network 110 via the network I/F 218. It should be noted that the cache servers 121 and 131, which are also implemented by personal computers (PCs), are different from the file server 111 only in functions, and have the same hardware configuration as that of the file server 111.

Basic programs, such as a basic input/output section (BIOS) and so forth, are stored in the ROM 212. The CPU 211 loads application programs and data stored in the storage device 214 in the RAM 213 based on the BIOS stored in the ROM 212, and executes the application programs.

The display device 217 not only displays various kinds of data but also is used as a UI for providing various kinds of instructions in an interactive form. The mouse 215 and the keyboard 216 are used as input devices for inputting various kinds of data and instructions.

The storage device 214 is comprised of large capacity storage devices, such as a hard disk, a magnetic tape, and a semiconductor memory. Stored in this storage device 214 are various kinds of application programs, shared files, and various other kinds of data, including programs for carrying out processes, described hereinafter. The various kinds of data stored in the storage device 214 include an access log, a print log, information managed by a DB (database) 302, and so forth.

It should be noted that the cache servers 121 and the like, and the client PC 113 and the like are also implemented by computers, similarly to the file server 111, and their hardware configurations are as shown in FIG. 2.

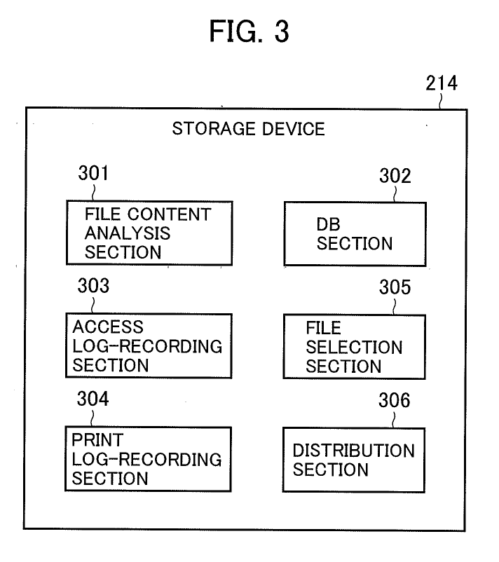

Next, the function of the file server 111 will be described with reference to FIG. 3. This function is realized by the application programs stored in the storage device 214 of the file server 111. These application programs are loaded into the RAM 213 of the file server 111, and are executed by the CPU 211.

A file content analysis section 301 is a program for analyzing the contents of files under the management of the file server 111, that is, shared files, and extracting feature elements indicative of the features of the shared files. Examples of the feature elements indicative of the features of the shared files include keywords that are important words, feature items of important images contained in the shared files, concept indexes indicative of concepts of written articles, metadata added to the shared files, and so forth.

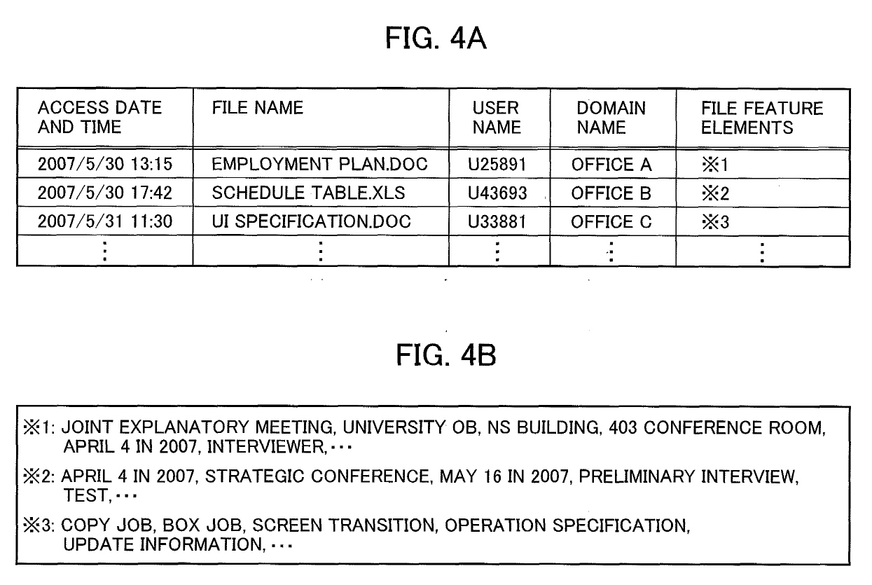

The DB (database) section 302 is a program for accumulating shared files. This DB section 302 registers (accumulates) the shared files in a manner associated with feature elements indicative of the features of files, which are the results of analysis by the file content analysis section 301. An access log-recording section 303 is a program for recording an access log from the client PC 113 and the like in the storage device 214 when the client PC 113 and the like access the shared files (DB). The format and the like of the access log will be described hereinafter with reference to FIGS. 4A and 4B.

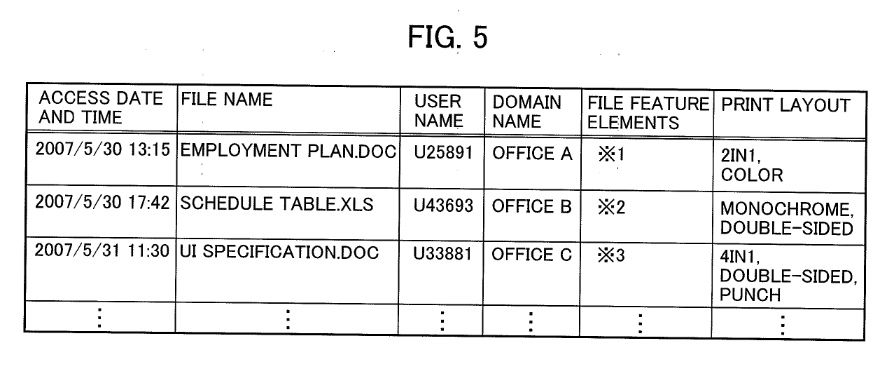

A print log-recording section 304 is a program for recording a print log in the storage device 214 when a shared file is printed by the MFP 112 and the like in response to a request from the client PC 113 and the like. The format and the like of the print log will be described hereinafter with reference to FIG. 5.

A file selection section 305 is a program for selecting a file to be copied into the cache servers 121 and 131, from the shared files. As described hereinafter, this selection process is performed using feature elements indicative of features of the shared files, the access log, and the print log. The access log and the print log are for recording access situations in which access is made to files already registered in the file server 111, from the client PC 113 and the like. More specifically, the access situations include not only respective situations of simple reading processes but also respective situations of reading processes caused by print requests.

A distribution section 306 is a program for distributing a file selected by the file selection section 305 to the cache servers 121 and 131.

The access log is recorded in a format shown in FIGS. 4A and 4B. More specifically, as shown in FIG. 4A, the access log includes data items, such as an “access date and time”, a “file name”, a “user name”, a “domain (name)”, and a “file feature element”.

The “access date and time” is a data item indicative of date and time when one of the client PC 113 and the like accessed a shared file. The “file name” is a data item indicative of the file mane of a shared file accessed by the one of the client PC 113 and the like. The “user name” is a data item indicative of the account name of a user who accessed the shared file.

The “domain name” is a data item indicative of the name of a group to which belongs the one of the client PC 113 and the like which accessed a shared file. The “domain name” is intended among other things particularly for identifying a physical section, such as an office or a floor. In the example illustrated in FIG. 1, the same domain name e.g. of an “office A” is assigned to the clients PCs 113 and 114 arranged in an office A. Similarly, the same domain name of an “office B” is assigned to the clients PCs 123 and 124 arranged in an office B. Similarly, the same domain name of an “office C” is assigned to the clients PCs 133 and 134 arranged in an office C.

Examples of the “domain name” include e.g. a network domain. More specifically, in the settings of the network, a subnet mask is generally set on a group-by-group basis to configure a local area network to thereby enhance communication efficiency and security. The subnet mask can be recorded as the “domain name” of the access log.

Further, a work group or the like as a function of an OS (Operating System) installed on the client PC 113 and the like may be used as the “domain name”. More specifically, in the OS, in general, a group name having a specific meaning is often assigned to the same work group, so that the name of the work group can be recorded as a “domain name” in the access log.

Furthermore, when the client PC 113 and the like access the file server 111, the “domain name” may be passed in the form of a parameter. In the example illustrated in FIG. 1, when the client PC 133 belonging e.g. to the office C accesses the file server 111, a character string of “office C” is passed to the file server 111 as a parameter associated with the “domain name”. This makes it possible for the file server 111 to record “office C” as data associated with the “domain name” in the access log.

In the present embodiment, it is assumed that each domain associated with a “domain name” has a cache server.

The “file feature element” includes data items indicative of the feature elements of an accessed shared file. This “file feature element” indicates the results of analysis by the file content analysis section 301. More specifically, examples of the “file feature element” include data items, such as keywords, the feature items of important images contained in the shared file, concept indexes indicative of the concepts of texts, metadata added to the shared files, and so forth (see FIG. 4B).

The above-described access log is stored in the storage device 214 of the file server 111 in a list format in the order of the “access date and time”. The access log can be represented in a format other than the format shown in FIGS. 4A and 4B.

The print log is recorded in a format appearing in FIG. 5. More specifically, as shown in FIG. 5, the print log includes data items, such as a “printing date and time”, a “file name”, a “user name”, a “domain”, a “file feature element”, and a “print layout”. Out of the above data items, the “file name”, the “user name”, the “domain”, and the “file feature element” are the same as the data items recorded in the access log and are different only in the kind of occasion in which they are recorded, i.e. “access” or “print”, and hence description thereof is omitted.

The “printing date and time” is a data item indicative of date and time when one of the client PC 113 and the like printed a shared file on the file server 111. The “print layout” is a data item indicative of print layout information set for printing the shared file.

The above-described print log is stored in the storage device 214 of the file server 111 in a list format in the order of the “printing date and time”. The print log can be shown in a format other than the format shown in FIG. 5.

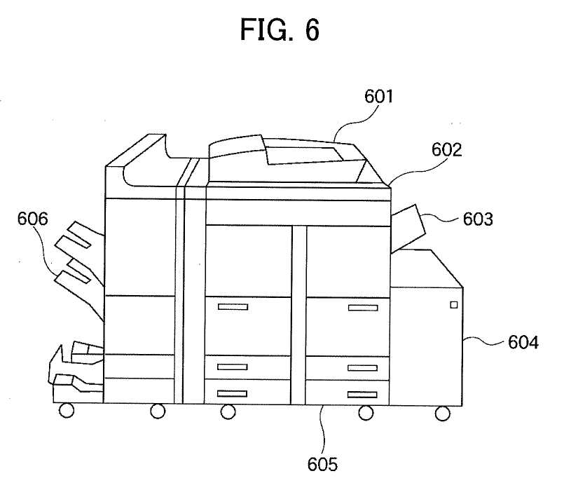

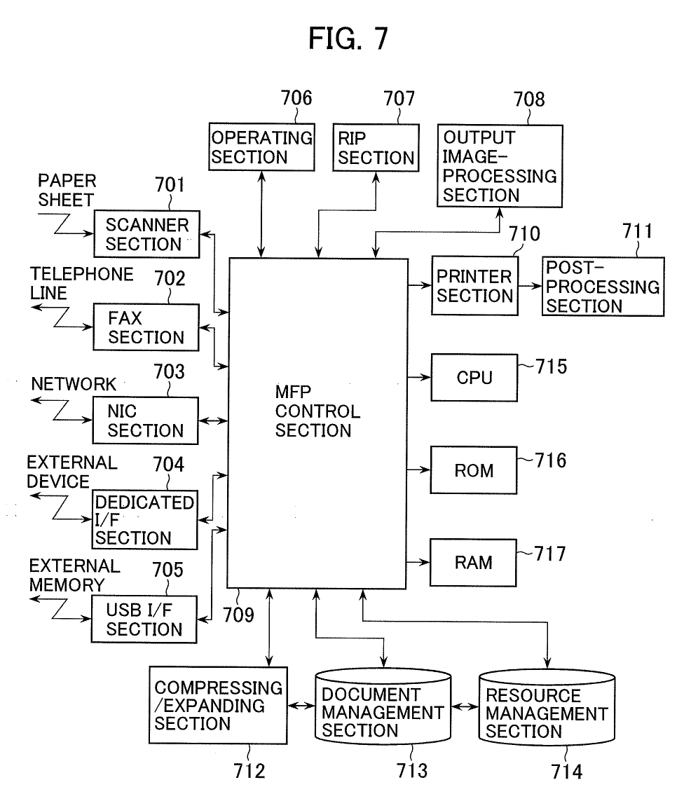

Next, the arrangement of the MFP 112 and the like will be described with reference to FIGS. 6 and 7. FIG. 6 is a view of the appearance of each of the MFP 112 and the like. Each of the MFP 112 and the like is an image forming apparatus having a plurality of functions, such as a copy function of printing image data read by a scanner using a printer section, and a print function of printing print data output from an external device using a printer section. As shown in FIG. 6, the MFP 112 and the like each include an ADF (Auto Document Feeder) 601, an operation panel 602, a multi manual feed tray 603, a side paper deck 604, a cassette paper deck 605, and a finisher 606.

The ADF 601 automatically feeds an original to an original reading position (on an original platen glass). The operation panel 602 is formed by a liquid crystal touch panel or the like, and is used for performing various settings and adjustments, and confirmation of apparatus conditions. The multi manual feed tray 603 is used for manually setting sheets of a particular use for feeding the same. The side paper deck 604 is capable of holding a large number of print sheets. The cassette paper deck 605 is capable of holding printing sheets having various sizes separately on respective decks on a sheet size basis. During an image forming process, the printing sheets are automatically picked up from the cassette paper deck 605, and are fed to a transfer section. The finisher 606 carries out various finishing processes, such as stapling, punching, binding, and so forth.

FIG. 7 is a block diagram showing the internal configuration of each of the MFP 112 and the like. The MFP 112 and the like each have a control system basically formed by a computer. More specifically, the MFP 112 includes a memory (not shown), such as a hard disk, which is capable of storing data of a plurality of jobs, a CPU 715, a RAM (main storage device) 717, and a ROM 718. The CPU 715 reads out and loads programs stored in the ROM 718 and the hard disk into the RAM 717, and sequentially executes the programs, to thereby realize the functions, such as the copy function, the FAX function, and so forth.

The MFP 112 and the like each include a scanner section 701, a fax section 702, an NIC (Network Interface Card) section 703, a dedicated I/F (Interface) section 704, a USB (Universal Serial Bus) I/F section 705. In addition, the MFP 112 and the like each include an operating section 706, a RIP section 707, an output image-processing section 708, an MFP control section 709, a printer section 710, a post-processing section 711, a compressing/expanding section 712, a document management section 713, and a resource management section 714.

The scanner section 701 optically reads an image on an original by a scanner (not shown), and converts the read image into electrical image data, to input the same to the MFP control section 709. The fax section 702 transmits and receives image data using the telephone line under the control of the MFP control section 709. The NIC 703 uses the network to transmit and receive image data and apparatus information between the same and external devices, such as computers, under the control of the MFP control section 709. The dedicated I/F section 704 exchanges information, such as image data, between the same and the external devices under the control of the MFP control section 709. The USB I/F section 705 transmits and receives image data and the like between the same and USB devices represented by a USB memory (a type of removable medium) under the control of the MFP control section 709.

The MFP control section 709 plays the role of a traffic controller that temporarily stores image data, and determines a transmission path of the image data according to a function that the MFP 112 or the like each is about to carry out. The document management section 713 stores image data from the scanner section 701, the NIC section 703, and so forth, as document files in the hard disk or the like under the control of the MFP control section 709. Further, the document management section 713 reads out image data from the hard disk, and transfers the read image data to the printer section 710 for causing the printer section 710 to print the image data, or transfers the read image data to external devices, such as personal computers and other image forming apparatuses, under the control of the MFP control section 709.

The compressing/expanding section 712 compresses image data stored in the hard disk or the like by the document management section 713, under the control of the MFP control section 709. Further, the compressing/expanding section 712 expands image data read from the hard disk or the like by the document management section 713, under the control of the MFP control section 709. In this case, the compressing/expanding section 712 can compress image data and expand the compressed image data by various kinds of compression methods, such as JPEG, JBIG, and ZIP.

The resource management section 714 stores a table registering various kinds of parameters, such as fonts, color profiles, and gamma correction values, commonly used between image data, in the hard disk or the like, under the control of the MFP control section 709. Further, the resource management section 714 reads out the above-described various kinds of parameters under the control of the MFP control section 709.

When PDL data is input, the MFP control section 709 causes the RIP section 707 to perform RIP (Raster Image Processor) processing on the PDL data, to thereby generate raster (scan) image data. Further, the MFP control section 709 causes the output image-processing section 708 to perform image processing on image data for printing, as required. Furthermore, the MFP control section 709 causes the document management section 713 to store intermediate data and print-ready data (raster image data and compressed data thereof) of image data generated during the RIP processing and the image processing, in the hard disk or the like again, as required.

The printer section 710 executes printing e.g. by electrophotography based on the image data having been subjected to the RIP processing or the image processing, under the control of the MFP control section 709. The post-processing section 711 carries out post-processing, such as assorting and stapling, on sheets printed out by the printer section 710.

The MFP control section 709 serves to smoothly carry out a sequence of processing concerning the input and output of image data, and performs switching of a path according to the use of the MFP, as follows. However, although it is generally known that image data is stored as intermediate data, as required, in the illustrated example, there is no description of accesses other than ones which are started from or terminated at the document management section 713. Further, description of processing by the compressing/expanding section 712 and the post-processing section 711, which are used, as required, or processing by the MFP control section 709, which becomes a core of the whole processing, is omitted, but description is given such that the general flow of the sequence of processing can be understood.

A) Copy function: Input image processing section→Output image-processing section→Printer section

B) FAX transmission function: Input image processing section→Fax section

C) FAX reception function: Fax section→Output image-processing section→Printer section

D) Network scanning: Input image processing section→NIC section

E) Network printing: NIC section→RIP section→Output image-processing section→Printer section

F) Scanning to external device: Input image processing section→Dedicated I/F section

G) Printing from external device: Dedicated I/F section→Output image-processing section→Printer section

H) Scanning to external memory: Input image processing section→USB I/F section

I) Printing from external memory: USB I/F section→RIP section→Output image-processing section→Printer section

J) Box scanning function: Input image processing section→Output image-processing section→Document management section

K) Box printing function: Document management section→Printer section

L) Box reception function: NIC section→RIP section→Output image-processing section→Document management section

M) Box transmission function: Document management section→NIC section

N) Preview function: Document management section→Operation section

In addition to the above, it is possible to envisage combinations of the above-mentioned functions and various other functions, such as E-mail service and a Web server function.

In all of the box scanning function, the box printing function, the box reception function, and the box transmission function, the document management section 713 manages image data by dividing the storage area of the memory (hard disk) to assign the divided areas to respective jobs or users.

The operating section 706 includes a display in addition to various kinds of input keys, and is used for selecting the above-described processing and functions and giving various kinds of instructions. On the display of the operating section 706, the image data managed by the document management section 713 can be displayed in advance e.g. for printing.

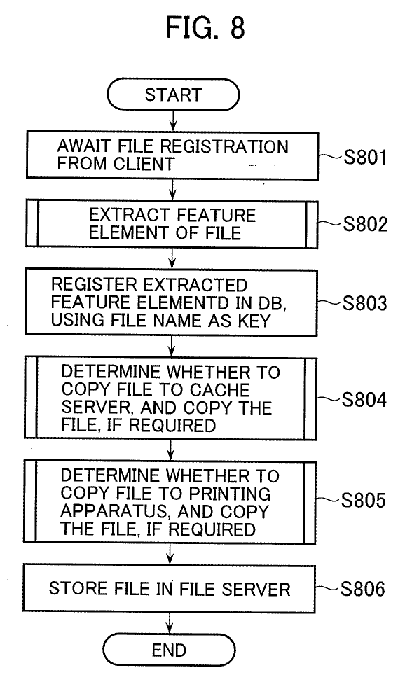

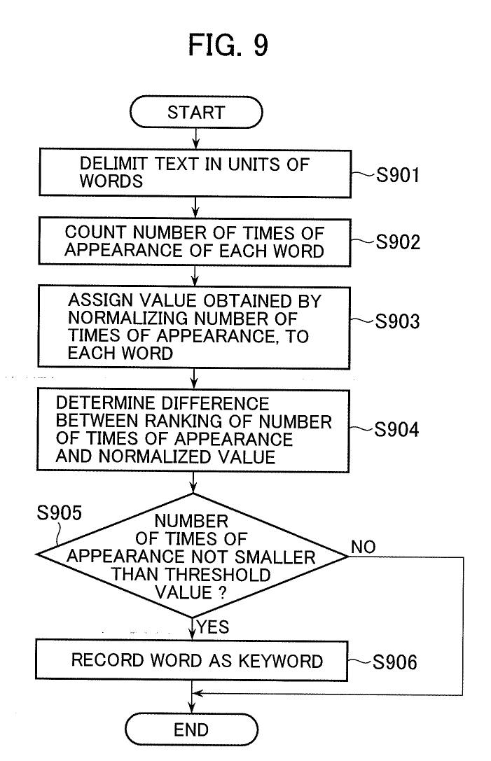

Next, a newly registering process for registering a new file, executed by the file server 111 will be described with reference to FIG. 8. Although the newly registering process in FIG. 8 is carried out by the CPU 211 of the file server 111, in the following description, the process is described such that it is executed by the file server 111 (this also applies to processing described hereinafter with reference to FIGS. 9 to 18).

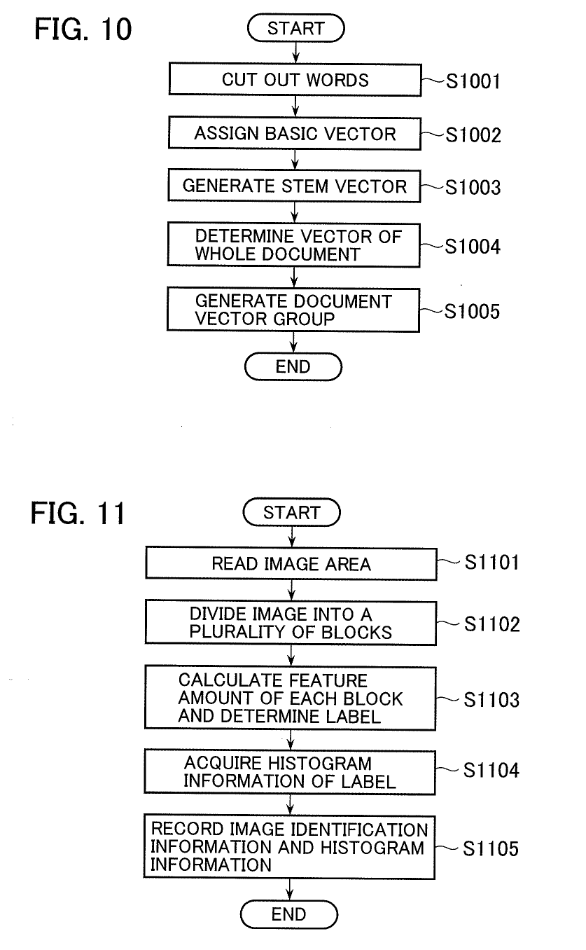

The file server 111 is awaiting a file registration request e.g. from the client PC 113 (step S801). When the file registration request is issued e.g. by the client PC 113, the file server 111 analyzes the content of a file transmitted together with the registration request using the file content analysis section 301, and extracts feature elements of the file (step S802). An example of a process for extracting the feature elements of the file will be described with reference to FIG. 9, FIG. 10, and FIG. 11.

Next, the file server 111 registers the extracted feature elements of the file in the DB section 302 (step S803). In this case, the feature elements of the file are registered using a file name as a key. This makes it possible to search for the feature elements using the file name as the key.

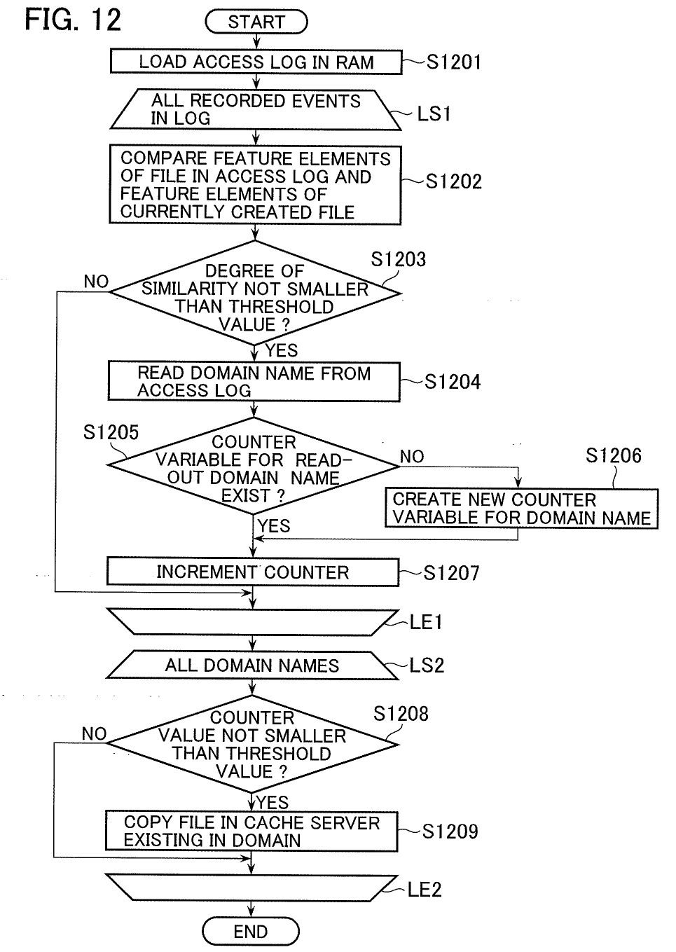

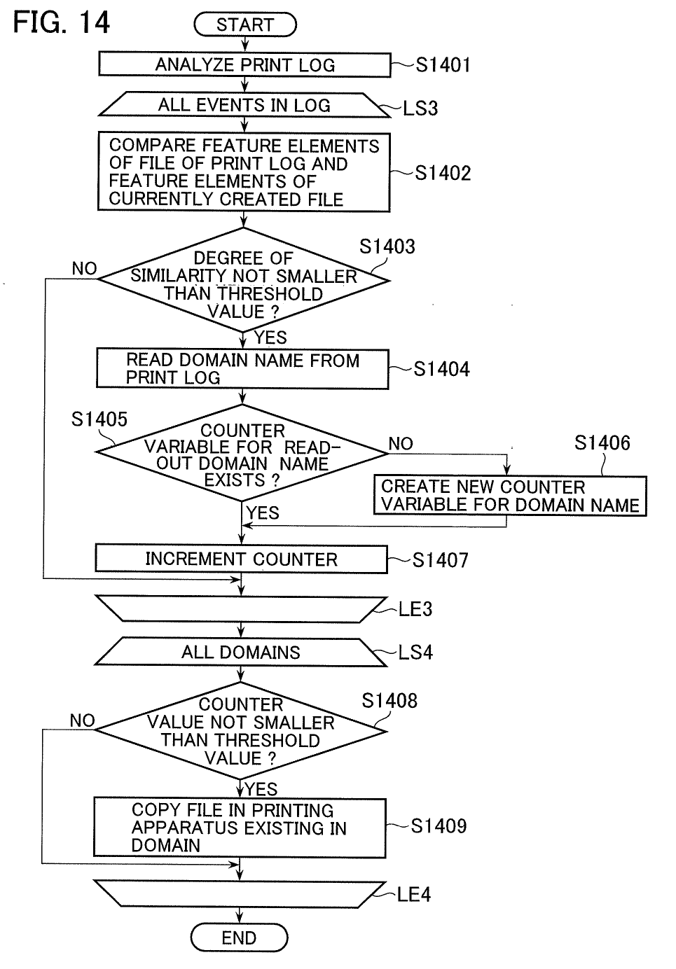

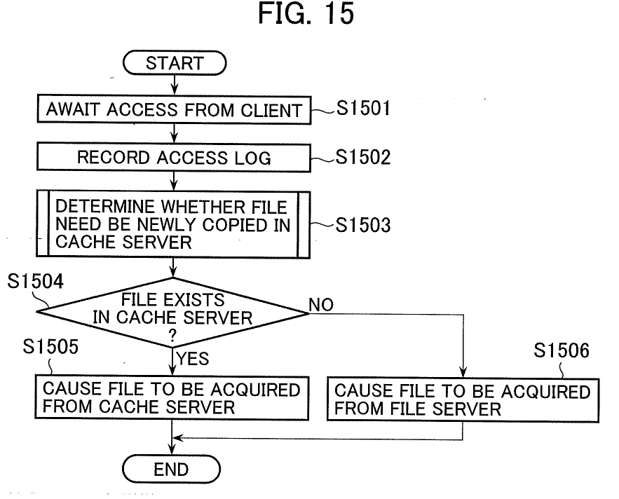

Next, the file server 111 copies the file associated with the registration request in the cache server 121 to cause the same to be registered therewith, as required, that is, the file server 111 transmits a duplicate of the file for registration to the cache server 121, and causes the same to be registered therewith (step S804). The details of this copying registration process will be described hereinafter with reference to FIG. 12. Next, the file server 111 copies and registers the file associated with the registration request, in the MFP 112 or the like as a printing apparatus, as required (step S805). This copying registration process is performed by the document management section 713 shown in FIG. 7, and details thereof will be described with reference to FIG. 14.

Next, the file server 111 stores (registers) the file associated with the registration request in the storage device 214 (step S806), followed by terminating the present newly registering process.

Next, the example of the process performed for extracting the feature elements of the file in the step S802 in FIG. 8 will be described with reference to FIG. 9, FIG. 10, and FIG. 11. Examples illustrated in FIG. 9, FIG. 10, and FIG. 11 are for extracting a keyword, a concept index, and the feature of an important image, as the feature elements of the file.

First, a description will be given of a case where a keyword is extracted as a feature element of the file, with reference to FIG. 9. The file server 111 delimits the text of the file (document data) associated with the registration request in units of words (step S901). Next, the file server 111 counts the number of times of appearance of each word (step S902). Then, the file server 111 arranges the words in the order of the number of times of appearance thereof for ranking them, and further assigns each word a value obtained by normalizing the number of times of appearance of the word using the total number of the kinds of the words that appeared in the document (step S903).

Next, the file server 111 determines the difference between the ranking of the number of times of appearance of each ranked word and the normalized value of the number of times of appearance of the word (step S904). Then, when the difference determined in the step S904 is not smaller than a threshold value, and the frequency of appearance of the word is high enough to exceed the range of an error, the word is extracted as the keyword, and recorded (steps S905 and S906).

Next, a description will be given of a case where a concept index defined as a superordinate term of keywords is extracted as a file feature element, with reference to FIG. 10. The file server 111 cuts out words in advance from a document for preparing a dictionary e.g. by morphological analysis (step S1001). Then, the file server 111 assigns' vectors (basic vectors) serving as bases to the respective cut-out words (step S1002).

Next, the file server Ill generates a vector group (stem vector) providing a dictionary function, based on the basic vectors (step S1003). Next, the file server 111 determines a vector of the whole file (document) associated with the registration request based on the stem vector generated in the step S1003 (step S1004). Then, the file server 111 generates a document vector of the document from the file (document) associated with the registration request, and records the document vector as the concept index (step S1005).

Next, a description will be given of a case where a feature of an important image is extracted as a file feature element, with reference to FIG. 11. The file server 111 reads the area of the image contained in the file (document) associated with the registration request (step S1101). Next, the file server 111 divides this image into a plurality of blocks (step S1102).

Next, the file server 111 performs a predetermined image feature amount-calculating process on an image of each block obtained in the step S1102 to thereby determine to which cell the image belongs in a multi-dimensional feature mount space, and determine an associated label (step S1103). This process is carried out on all the blocks. More specifically, the file server 111 performs the above calculating process on each image block obtained by the division, to determine to which color cells all the pixels of the image block belong, and determines the label of a color cell in which pixels occur with the highest frequency as a parameter label (color label) of the image block.

Next, the file server 111 acquires histogram information of the color label of each image block (step S1104). Next, the file server 111 records identification information of the image and attribute information such as the histogram information and the like acquired in the step S1104, in a manner associated with each other (step S1105).

As the feature element of a file, metadata stored together with the file may be extracted. To the metadata, there applies information indicative of characteristic features of the file, e.g. information indicative of a creator name, a date, or the contents (keywords and the like) of the file, and it is given to the file in the course of creation thereof e.g. in the XML format. If this metadata is given to the file, it is only required in the step S802 in FIG. 8 to extract elements (keywords or the like) indicative of the contents of the file from the metadata.

Next, the copying registration process carried out in the step S804 in FIG. 8 will be described in detail with reference to the flowchart shown in FIG. 12.

The file server 111 loads the access log stored in the storage device 214, in the RAM 209 so as to analyze the access log (step S1201). As shown in FIGS. 4A and 4B, the access log is recorded in the form of a list in the order of the access date and time. Therefore, the file server 111 sequentially performs a process in steps S1202 to S1207 in a loop from LS1 (indicative of the start of the loop) to LE1 (indicative of the end of the loop) on all recorded events of the access log one by one in order from the first event in the list.

More specifically, the file server 111 compares feature elements of a file in the access log to which the file server 111 is currently paying attention and the feature elements of the file associated with the registration request which were extracted in the step S802 in FIG. 8 (step S1202). Then, the file server 111 determines whether or not the degree of similarity in feature elements between the two is not smaller than a threshold value (step S1203). In this determination process, when the feature elements of a file are keywords, the file server 111 compares keywords in the access log to which the file server 111 is currently paying attention and keywords of the file associated with the registration request, and judges that as the number of keywords matching each other is larger, the degree of similarity in feature elements is higher.

The above method of determining the degree of similarity in feature elements is only the simplest example, and it is possible to determine the degree of similarity by various methods other than the above. For example, a method of calculating the degree of similarity by a vector space method is widely known as a method of determining the degree of similarity using keywords. There exist various methods other than the illustrated examples.

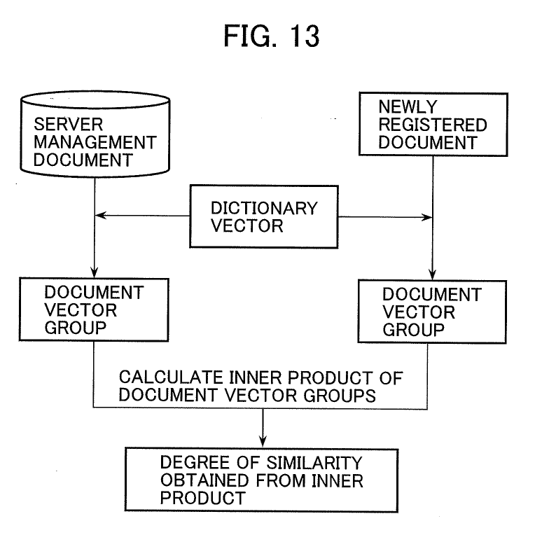

Further, when the feature elements of a file are concept indexes, the degree of similarity can be calculated by concept-based search. For example, when a document vector group extracted by the method shown in FIG. 10 is recorded as a concept index, the degree of similarity is determined in such a manner as illustrated in FIG. 13. More specifically, the inner product of a feature element of a file (concept index: a document vector group associated with a document managed by the server) in the access log, and the document vector group associated with the file (document) associated with the registration request is calculated, and it is judged that the degree of similarity is higher as the value of the inner product is higher.

Further, when the feature elements of a file are the features of images contained in the file, the file server 111 compares the features of the images to calculate the degree of similarity. For example, when histogram information is recorded as the feature elements of each image by the method shown in FIG. 11, the file server 111 calculate the degree of similarity by comparing the recorded histogram information and the feature elements (histogram information) of a file in the access log. Further, when the feature elements of a file are metadata, the method of calculating the degree of similarity is different depending on information contained in the metadata. For example, when the information contained in the metadata is formed of keywords, the above-described calculation using keywords is performed for calculating the degree of similarity.

If the file server 111 judges in the step S1203 that the degree of similarity between the feature elements is not smaller than the threshold value, the file server 111 reads out a domain name from the access log to which it is currently paying attention (step S1204). Next, the file server 111 determines whether or not a counter (counter variable) associated with the domain name read out exists in the RAM 213 (step S1205). If it is determined that there exists no counter, the file server 111 newly creates a counter for the domain name in the RAM 213 (step S1206), and increments the counter (step S1207). On the other hand, if there exists a counter associated with the domain name read out, the file server 111 increments the counter (by +1) (step S1207).

By performing the above-described process in the loop from LS1 to LE1, using the counter value of a counter for each domain name, it is possible to grasp the number of times of access to a file having a high degree of similarity to the file associated with the registration request from the client PC 113 and the like belonging to the domain having the domain name. The process in the loop from LS1 to LE1 has a meaning that a search is made for a registered file having a high degree of similarity to a newly registered file.

Next, the file server 111 carries out a process in steps S1208 and S1209 in a loop from LS2 (indicative of the start of the loop) to a loop LE2 (indicative of the end of the loop), on all the domains.

More specifically, when the value of a counter corresponding to a domain to which the file server 111 is currently paying attention is not smaller than a threshold value (step S1208), the file server 111 copies and registers the file associated with the registration request, in the cache server 121 or 131 existing in the domain (step S1209).

By the above-described copying registration process, if there is a domain from which a registered file having a high degree of similarity to the file associated with the current registration request is accessed a number of times larger than the threshold value, a copy of the file associated with the current registration request is also registered in the cache server belonging to the domain.

Next, the copying registration process in the step S805 appearing in FIG. 8 will be described in detail with reference to FIG. 14.

The file server 111 loads the print log stored in the storage device 214, in the RAM 209 so as to analyze the print log (step S1401). As shown in FIG. 5, in this print log, events are recorded in the form of a list in the order of the printing date and time. Therefore, the file server 111 sequentially performs steps S1402 to S1407 in a loop from LS3 (indicative of the start of the loop) to LE3 (indicative of the end of the loop) on all events in the print log one by one in order from the first event in the list.

More specifically, the file server 111 compares feature elements of a file to which the file server 111 is currently paying attention in a print log and the feature elements of the file associated with the registration request which were extracted in the step S802 in FIG. 8 (step S1402). Then, the file server 111 determines whether or not the degree of similarity in feature elements between the two is not smaller than a threshold value (step S1403). In this determination process, when the feature elements of the file are keywords, the file server 111 compares keywords in the print log to which the file server 111 is currently paying attention and keywords of the file associated with the registration request, and judges that the degree of similarity in feature elements is higher as the number of keywords matching each other is larger. The above method of determining the degree of similarity in feature elements is only the simplest example, and it is possible to determine the degree of similarity by the above-described various methods other than this.

If the file server 111 judges in the step S1403 that the degree of similarity in feature elements is not smaller than the threshold value, the file server 111 reads out a domain name from the print log to which it is currently paying attention (step S1404). Next, the file server 111 determines whether or not a counter (counter variable) associated with the domain name read out exists in the RAM 213 (step S1405). If it is determined that there exists no counter, the file server 111 newly creates a counter for the domain name within the RAM 213 (step S1406), and increments the counter (step S1407). On the other hand, if there exists a counter associated with the domain read out, the file server 111 increments the counter (by +1) (step S1407).

By performing the above-described process in the loop from LS3 to LE3, using the counter value of a counter for each domain name, it is possible to grasp the number of times of access to (in this case, the number of times of printing of) a file having a high degree of similarity to the file associated with the registration request from the client PC 113 and the like belonging to the domain having the domain name.

Next, the file server 111 carries out a process in steps S1408 and S1409 in a loop from LS4 (indicative of the start of the loop) to a loop LE4 (indicative of the end of the loop), on all the domains.

More specifically, when the value of a counter corresponding to a domain to which the file server 111 is currently paying attention is not smaller than a threshold value (step S1408), the file server 111 copies and registers the file associated with the registration request, in the MFP 122 or 132 existing in the domain (step S1409). The MFP 122 or 132 stores files in the document management section 713 thereof in an image format suitable for high-speed printing by the printer section. Therefore, in the step S1409, a file converted by the file server 111 into an image format suitable for registering in the MFP 122 or 132 may be copied and registered. It is to be understood that the image format may be converted by the MFP 122 or 132.

By the above-described copying registration process, if there is a domain from which a registered file having a high degree of similarity to the file associated with the current registration request is accessed a number of times larger than the threshold value, a copy of the file associated with the current registration request is also registered (cached) in the MFP 122 or 132 belonging to the domain. Thus, by registering a file which is used for printout, i.e. printed out at a high frequency, in the MFP 122 or 132, it is possible to more efficiently print out the file.

Next, a process which is executed by the file server 111 having received an access request (file read request) from the client PC 113 or the like will be described with reference to FIG. 15.

Upon reception of an access request (file read request) from the client PC 113 (step S1501), the file server 111 records (updates) the access log in the format shown in FIGS. 4A and 4B (step S1502).

In this case, as to the access date and time, a date and time on which the client PC 113 or the like made the access request to the file server 111 is recorded. As to the file name, the file name of a file requested to be accessed by the client PC 113 or the like is recorded. As to the user name, the account name of a user who made the file access is recorded. As to the domain name, there is recorded information, such as subnet information of the network, or information having been passed as a parameter during the file access, which is indicative of a domain to which the client PC 113 or the like belongs. As to the feature elements of the file, there are recorded feature elements found by searching the DB section 302 using, as a key, the file name of the file associated with the access request.

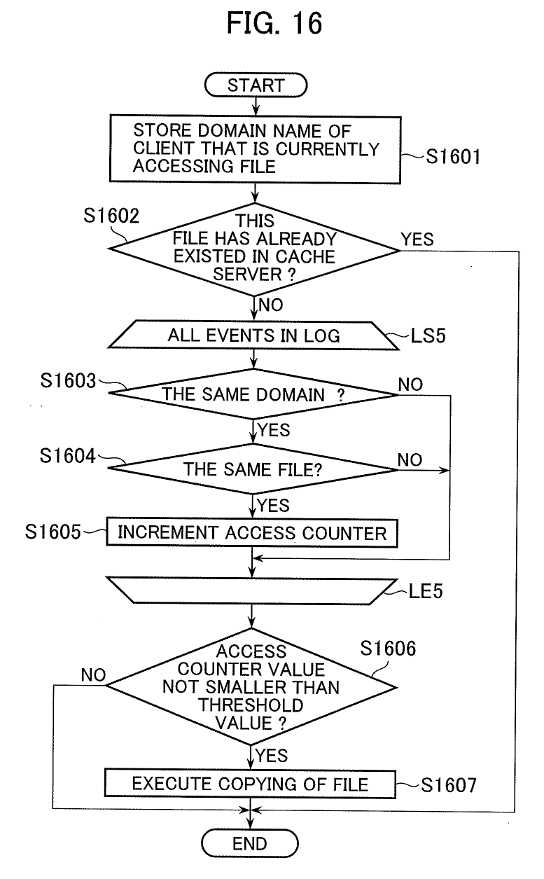

Next, the file server 111 determines whether or not the updating of the access log in the step S1502 makes it necessary to newly copy and register the file in the cache server 121 and the like (step S1503). This process in the step S1503 will be described in detail with reference to FIG. 16.

Next, the file server 111 determines whether or not the file associated with the current access request exists in a cache server existing in the domain to which a client PC having made the access request belongs (step S1504).

If it is determined that the file exists in the cache server, the file server 111 instructs the client PC that has made the access request, to acquire the file associated with the current access request from the cache server (step S1505). In this case, by acquiring the file from the cache server, the instructed client PC is capable of acquiring the file at a higher speed than when it acquires the file from the file server 111 at a physically distant location.

On the other hand, if the file does not exist in the cache server, the file server 111 instructs the client PC that has made the access request, to acquire the file associated with the current access request from the storage device 214 of the file server 111 (step S1506).

Next, the process in the step S1503 in FIG. 15 will be described in detail with reference to the FIG. 16.

The file server 111 stores the domain name of the domain to which belongs the client PC associated with the current access request, in a variable prepared in the RAM 213 (step S1601). This domain name is the same information as recorded in the access log in the step 1502 in FIG. 15.

Next, the file server 111 determines whether or not the file associated with the current access request has already been copied and registered in the cache server 121 or 131 which exists in the domain including the client PC that has made the access request (step S1602). If it is determined that the file has already been copied and registered, the file server 111 immediately terminates the present process.

On the other hand, if the file has not been registered by copying the same, the file server 111 carries out a process in steps S1603 and S1605 in a loop from LS5 (indicative of the start of the loop) to a loop LE5 (indicative of the end of the loop), on all events in the access log. More specifically, the file server 111 determines whether or not a domain in the access log to which the file server 111 is currently paying attention is identical to the domain to which the client PC 113 or the like associated with the current access request belongs (step S1603).

If it is determined that the domains are identical, the file server 111 determines whether or not a file in the access log to which the file server 111 is currently paying attention, and the file associated with the current access request are identical (step S1604). If it is determined that the files are identical, the file server 111 increments (increases by 1) an access counter associated with the file (step S1605).

Then, after termination of the process associated with the loop from LS5 to LE5, the file server 111 determines whether or not the value of the above-described access counter has become not smaller than a threshold value (step S1606). If it is determined that the value of the above-described access counter has become not smaller than the threshold value, the file server 111 copies and registers the file associated with the access counter in the cache server 121 or 131 existing in the domain (step S1607). On the other hand, if the value of the above-described access counter is smaller than the threshold value, the file server 111 terminates the present process without performing the above-described copying and registration, i.e. caching.

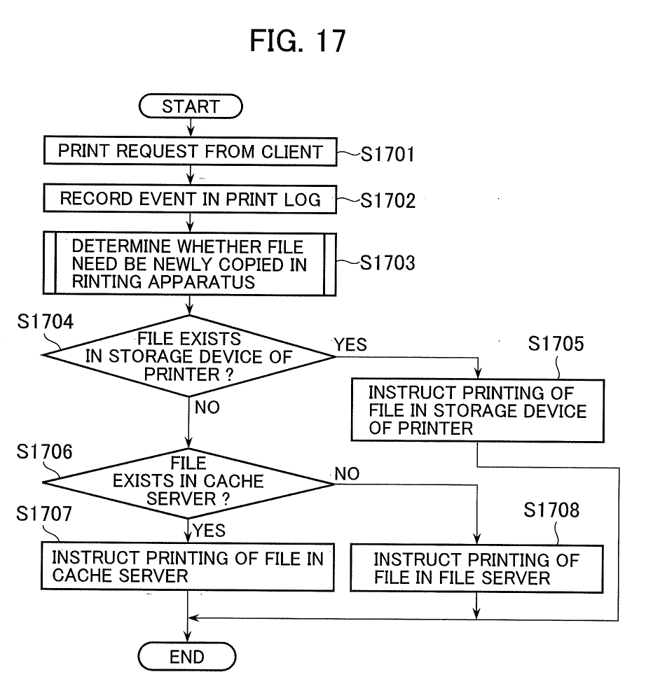

Next, a process which is executed by the file server 111 having received an access request (print request, in this process) from the client PC 113 or the like will be described with reference to FIG. 17.

Upon reception of an access request (print request) from the client PC 113 (step S1701), the file server 111 performs recording of this event (updating) the print log in the format shown in FIG. 5 (step S1702).

In this case, as to the printing date and time, date and time on which the client PC 113 or the like made the print request to the file server 111 is recorded. As to the file name, the file name of a file requested to be printed by the client PC 113 or the like is recorded. As the user name, the account name of a user who made the print request is recorded. As to the domain name, there is recorded information, such as subnet information of the network, or information having been passed as a parameter during the print request, which is indicative of a domain to which the client PC 113 or the like belongs. As to the feature elements of a file, there are recorded feature elements found by searching the DB section 302 using, as a key, the file name of the file associated with the access request.

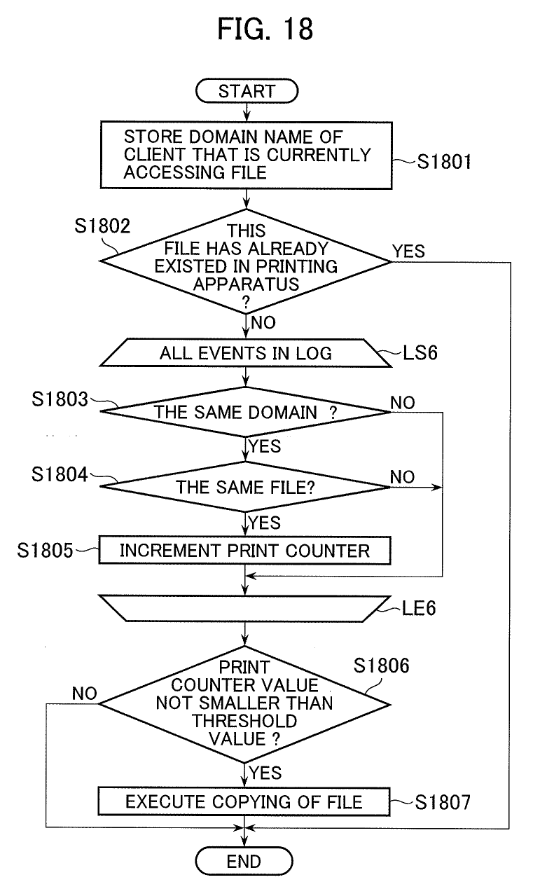

Next, the file server 111 determines whether or not the updating of the print log in the step S1702 makes it necessary to newly copy and register the file in the printing apparatus (MFP 122 or 132) (step S1703). This process in the step S1703 will be described in detail with reference to FIG. 18.

Next, the file server 111 determines whether or not the file associated with the current print request has already been copied and registered in the printing apparatus (MFP 122 or 132) which exists in the domain including the client PC that has made the print request (step S1704). If it is determined that the file associated with the current print request exists in the above-mentioned printing apparatus, the file server 111 instructs the client PC having made the print request, to acquire the file associated with the current print request from the printing apparatus to print the file (step S1705).

On the other hand, if the file associated with the current print request does not exist in the above-mentioned printing apparatus, the file server 111 determines whether or not the file exists in the cache server (step S1706). If it is determined that the file associated with the current print request exists in the cache server, the file server 111 instructs the client PC having made the print request to acquire the file associated with the current print request from the cache server to print the file (step S1707).

As described above, by acquiring the file associated with the print request from the printing apparatus or the cache server, the file can be acquired at a higher speed than when it is acquired from the file server 111 at a physically distant location.

On the other hand, if the file associated with the current print request does not exist in the cache server, the file server 111 instructs the client PC having made the print request, to acquire the file associated with the current print request from the storage device 214 of the file server 111 to print the file (step S1708).

Next, the process in the step S1703 in FIG. 17 will be described in detail with reference to FIG. 18.

The file server 111 stores the domain name of a domain to which belongs the client PC associated with the current access request (print request, in this process), in a variable prepared in the RAM 213 (step S1801). This domain name is the same information as recorded in the print log in the step 1702 in FIG. 17.

Next, the file server 111 determines whether or not the file associated with the current print request has already been copied and registered in the MFP 122 or 132 which exists in the domain to which the client PC that has made the print request belongs (step S1802). If it is determined that the file has already been copied and registered (cached), the file server 111 immediately terminates the present process.

On the other hand, if the file has not been copied and registered (cached), the file server 111 carries out a process in steps S1803 and S1805 in a loop from LS6 (indicative of the start of the loop) to a loop LE6 (indicative of the end of the loop), on all events in the print log. More specifically, the file server 111 determines whether or not a domain name in the print log to which the file server 111 is currently paying attention is identical to the domain name of a domain to which the client PC 113 or the like associated with the current print request belongs (step S1803).

If is determined that the domains are identical, the file server 111 determines whether or not a file in the print log to which the file server 111 is currently paying attention and the file associated with the current print request are identical (step S1804). If it is determined that the files are identical, the file server 111 increments (increases by 1) a print counter associated with the file (step S1805).

Then, after termination of the process in the loop from LS6 to LE6, the file server 111 determines whether or not the value of the above-mentioned print counter has become not smaller than a threshold value (step S1806). If it is determined that the value of the above-mentioned print counter has become not smaller than the threshold value, the file server 111 copies and registers the file associated with the print counter in the MFP 122 or 132 existing in the domain (step S1807). On the other hand, if the value of the above-mentioned print counter is smaller than the threshold value, the file server 111 terminates the present process without performing the above-described copying and registration, i.e. caching.

Although in the present embodiment, the number of times of access to each file in the file server 111 is counted for each domain, it may be counted for each client that can access to the file server 11. In this case, a client may be identified which accesses a file having a high degree of similarity to the file newly registered in the file server 111 at a higher frequency, and then, a copy of the file newly registered may be transmitted to the client.

It is to be understood that the present invention may also be accomplished by supplying a system or an apparatus with a storage medium in which a program code of software, which realizes the functions of each of the above described embodiments, is stored, and causing a computer (or CPU or MPU) of the system or apparatus to read out and execute the program code stored in the storage medium.

In this case, the program code itself read from the storage medium realizes the functions of each of the above described embodiments, and therefore the program code and the storage medium in which the program code is stored constitute the present invention.

Examples of the storage medium for supplying the program code include a floppy (registered trademark) disk, a hard disk, a magnetic-optical disk, an optical disk, such as a CD-ROM, a CD-R, a CD-RW, a DVD-ROM, a DVD-RAM, a DVD-RW, or a DVD+RW, a magnetic tape, a nonvolatile memory card, and a ROM. Alternatively, the program may be downloaded via a network.

Further, it is to be understood that the functions either of the above described embodiments may be accomplished not only by executing the program code read out by a computer, but also by causing an OS (operating system) or the like which operates on the computer to perform a part or all of the actual operations based on instructions of the program code.

Further, it is to be understood that the functions either of the above described embodiments may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2008-027802 filed Feb. 7, 2008, which is hereby incorporated by reference herein in its entirety.

What is claimed is:

1. A file management apparatus that manages files shared by a plurality of client terminals, comprising:
a recording unit configured to record access situations in which access is made to the files registered in the file management apparatus from the client terminals;
a search unit configured to search said recording unit for a file having a not smaller degree of similarity to a file newly registered in the file management apparatus than a predetermined threshold value; and
a distribution unit configured to distribute the newly registered file to any of the client terminals from which access has been made to the file found by the search a not smaller number of times than a predetermined number of times.

2. The file management apparatus according to claim 1, wherein said recording unit records a history of reading processes performed on the files registered in the file management apparatus by the client terminals, as the access situations.

3. The file management apparatus according to claim 2, wherein the history of the reading processes includes a history of reading processes executed on the files registered in the file management apparatus in response to print requests from the client terminals.

4. The file management apparatus according to claim 1, wherein said recording unit records feature information extracted from each registered file, in association therewith;
the file management apparatus further comprising an extraction unit configured to extract feature information on the file newly registered, and
wherein said search unit searches said recording unit for the file having a not smaller degree of similarity to the file newly registered, using the feature information extracted by said extraction unit and the feature information recorded in said recording unit.

5. The file management apparatus according to claim 4, wherein the feature information on the file comprises keywords included in the file.

6. The file management apparatus according to claim 4, wherein the feature information on the files comprises concept indexes.

7. The file management apparatus according to claim 4, wherein the feature information on the file comprises features of images included in the files.

8. The file management apparatus according to claim 4, wherein the feature elements of the files are metadata representative of contents of the files.

9. The file management apparatus according to claim 1, wherein said distribution unit distributes a duplicate of the file registered in the file management apparatus to a cache server for registering duplicates of ones of the files registered in the file management apparatus.

10. A file management apparatus according to claim 1, wherein said distribution unit further distributes the registered file found by the search by said search unit to an image forming apparatus by which the file is printed in a not lower frequency than a predetermined threshold value.

11. A file management method for a file management apparatus, for managing files shared by a plurality of client terminals, comprising:
recording access situations in which access is made to the files registered in the file management apparatus from the client terminals;
searching for a file having a not smaller degree of similarity to a file newly registered in the file management apparatus than a predetermined threshold value; and
distributing the newly registered file to any of the client terminals from which access has been made to the file found by the search a not smaller number of times than a predetermined number of times.

12. A computer-readable storage medium storing a program for causing a computer to execute a file management method for a file management apparatus, for managing files shared by a plurality of client terminals,
wherein the method comprises:
recording access situations in which access is made to the files registered in the file management apparatus from the client terminals;
searching for a file having a not smaller degree of similarity to a file newly registered in the file management apparatus than a predetermined threshold value; and
distributing the newly registered file to any of the client terminals from which access has been made to the file found by the search a not smaller number of times than a predetermined number of times.
